(19) United States
(12) Patent Application Publication
(10) Pub. No.: US 2015/0180893 A1
(43) Pub. Date: Jun. 25, 2015

(54) BEHAVIOR DETECTION SYSTEM FOR DETECTING ABNORMAL BEHAVIOR

(71) Applicant: KOREA INTERNET & SECURITY AGENCY, Seoul (KR)

(72) Inventors: Chae Tae IM, Seoul (KR); Joo Hyung OH, Seoul (KR); Dong Wan KANG, Seoul (KR); Eun Byol KOH, Seoul (KR); Hyun Seung PARK, Incheon (KR); Tae Eun KIM, Anyang-si (KR); Chang Min JO, Seoul (KR)

(73) Assignee: KOREA INTERNET & SECURITY AGENCY, Seoul (KR)

(21) Appl. No.: 14/227,239

(22) Filed: Mar. 27, 2014

(30) Foreign Application Priority Data
Dec. 24, 2013 (KR) 10-2013-0162162

(51) Int. Cl. H04L 29/06; H04L 29/08

(52) U.S. Cl. CPC H04L 63/1416; H04L 67/22

(57) ABSTRACT

Disclosed is a behavior detection system for detecting an abnormal behavior, can perform dynamic control based on situation information and a profile of each user to cope with an element threatening security of an internal infrastructure of an enterprise, such as information leakage, in BYOD and smart work environment. The system calculates probabilities of behaviors occurring for respective connection behavior elements, calculates standard deviations of the probabilities based on weighting factors and determines whether or not the calculated behavior occurrence probabilities and behavior standard deviation correspond to a normal behavior, existence of an abnormal connection behavior in a BYOD and smart work environment is detected and an abnormal user is detected by examining whether or not an average traffic volume, an average use time and traffic volume with respect to a use time exceeds respective standard values.

### BACKGROUND OF THE INVENTION

1. Field of the Invention

The present invention relates to a behavior detection system for detecting an abnormal behavior, and more specifically, to a behavior detection system for detecting an abnormal behavior, which can perform dynamic control based on situation information and a profile of each user to cope with an element threatening security of an internal infrastructure of an enterprise, such as information leakage or the like, in a bring your own device (BYOD) and smart work environment.

2. Background of the Related Art

Owing to construction of wireless Internet environments, generalization of smart devices such as a tablet PC, a smart phone and the like, desktop virtualization, increase of utilizing cloud services, putting emphasis on real-time communication and continuity of a work, and the like, development of a BYOD and smart work environment, which is a new IT environment, is accelerated.

From the standpoint of an enterprise, the BYOD tends to be actively adopted to enhance productivity and efficiency of a work and save cost for purchasing equipment or the like. As the age of BYOD is arriving like this, the internal infrastructure of an enterprise is changed from a closed environment to an open environment. A personal device is allowed to access the infrastructure of an enterprise regardless of time and space.

A personal device may access the infrastructure of an enterprise inside the enterprise through a wireless router (AP), a switch or the like, and the infrastructure of the enterprise may be accessed from outside of the enterprise through a mobile communication network, a public WiFi, a VPN or the like.

Although continuity and convenience of a work are obtained as the internal infrastructure of an enterprise is changed to an open environment as described above, threat to security, which is unimaginable before, also frequently occurs. Above all, as the personal device accesses the internal infrastructure of an enterprise, risk of leaking internal data of the enterprise is increased. That is, the internal data of the enterprise may be leaked when the personal device is lost or stolen, and IT assets of the enterprise may be threatened when a personal device infected with a malicious code connects to the internal intranet.

NAC and MDM may be illustrated as security techniques spotlighted recently in the BYOD and smart work environment in response to the threat to the IT assets described above. The NAC technique is a technique of controlling network access according to whether or not a terminal is abnormal by examining whether or not a user PC (terminal) abides by a security policy before the terminal connects to an internal network.

Since the main object of the NAC is user authentication and access control, the NAC is in lack of a function for detecting and coping with an abnormal behavior of a user or a terminal after they access a network. In addition, since the NAC is centered on authentication based on a registered user, it is also in lack of a function of authenticating a terminal device.

Above all, since the NAC is born to block network access itself, it is in lack of security specialties for protecting enterprise data by isolating a user of an abnormal behavior, none the less to say that it should guarantee utilization of various personal devices and continuity of a work as described above.

On the other hand, the MDM is a system which remotely provides functions such as registering/managing a terminal, suspending use of a lost terminal, tracing and managing a terminal and the like using an over the air (OTA) technique (a wireless transmission technique of a cellular phone) regardless of time and space if a mobile device is in a power-on state.

However, since the MDM is a kind of application, it is difficult to control and monitor accesses of other applications.

In addition, the MDM cannot access a network layer of a system level and cannot perform a behavior analysis on a network data. Above all, since users are unwilling to install an MDM agent in a personal device as personal privacy is requested to be protected, it is difficult to distribute and spread the MDM, and, in addition, the cost for continuously conducting version control on a variety of terminal devices is increased.

As described above, the conventional NAC and MDM described above have a limit in protecting internal resources in a BYOD and smart work environment.

### SUMMARY OF THE INVENTION

Therefore, the present invention has been made in view of the above problems, and it is an object of the present invention to provide a behavior detection system for detecting an abnormal behavior in a BYOD and smart work environment by processing situation information collected from a terminal device and an MDM agent device.

In addition, another object of the present invention is to provide a behavior detection system for detecting an abnormal behavior related to an abnormal connection of a user by profiling each user (which means identifying a specific entity and creating a set which can describe behaviors of the entity) and accumulating normal behaviors of the user stored while performing a work.

In addition, still another object of the present invention is to provide a behavior detection system for detecting an abnormal behavior, the system can detect in real-time abnormal connection elements which are compared with normal behavior patterning elements based on real-time situation information such as a connection time and location of a user, records of previous behaviors, a normal profile configuring average values and statistical values of all users in the system and the like.

The characteristics of the present invention for accomplishing the objects of the present described above and performing characteristic functions of the present invention described below are as follows.

According to one aspect of the present invention, there is provided a behavior detection system for detecting an abnormal behavior of a user in a BYOD and smart work environment, the system including: a situation information collection system for collecting situation information from a terminal device and an MDM agent device; an information database for processing and storing the collected situation information as connection, use and agent situation information and profiling the situation information at a time of disconnection to process and store the situation information as profile information; and an abnormal behavior detection system for detecting an abnormal behavior related to connection and use of the terminal device of the user using normal profile information included in the profile information.

Here, the abnormal behavior detection system according to one aspect of the present invention may detect connection, use and abnormal behavior of a connected terminal device of a user conducted on an agent based on the connect, use and agent situation information and further detect an abnormal behavior related to the connection and use of the terminal device of the user based on the profile information according to a security policy.

In addition, the abnormal behavior detection system according to one aspect of the present invention may include: a connection behavior pattern extraction unit for extracting a plurality of pieces of connection behavior pattern information having connection behavior elements of a same series from the normal profile information among the profile information; a matrix storage unit for creating a matrix of connection behavior pattern information by matching the plurality of pieces of connection behavior pattern information other than certain connection behavior pattern information among the plurality of pieces of connection behavior pattern information to the certain connection behavior pattern information for each piece of the connection behavior pattern information; a connection behavior element extraction unit for extracting a first connection behavior element of the first current behavior included in the certain connection behavior pattern information; and a first occurrence probability calculation unit for calculating a current behavior occurrence probability of the first connection behavior element under behaviors of the other connection behavior pattern elements.

In addition, the abnormal behavior detection system according to one aspect of the present invention may further include a second occurrence probability calculation unit for determining whether or not other second connection behavior elements for calculating the current behavior occurrence probability exist among the certain connection behavior pattern information and, if other second connection behavior elements for calculating the current behavior occurrence probability exist as a result of the determination, extracting the second connection behavior elements of a next current behavior included in the certain connection behavior pattern information and further calculating a current behavior occurrence probability for each of the second connection behavior elements.

In addition, the abnormal behavior detection system according to one aspect of the present invention may further include an abnormal connection confirmation unit for confirming, if it is determined that the other second connection behavior elements do not exist any more as a result of the determination, whether or not there is an abnormal connection behavior by calculating a weighted average and a standard deviation of the behavior occurrence probabilities for each of the first connection behavior element and the second connection behavior element and determining whether or not a connection behavior is within a range of a normal behavior occurrence probability and a normal standard deviation.

In addition, the abnormal behavior detection system according to one aspect of the present invention may include: a traffic use time extraction unit for inquiring first device profile information among the profile information and extracting average traffic volume information and average use time information per connection; a first traffic volume determination unit for determining whether or not a traffic volume per connection acquired from second device profile information generated while being connected exceeds the average traffic volume information; a use time determination unit for determining, if it is determined that the traffic volume per connection exceeds the average traffic volume information as a result of the determination of the first traffic volume determination unit, whether or not a use time per connection acquired from the second device profile information exceeds the average use time information; a traffic use time determination unit for determining, if it is determined that the use time per connection exceeds the average use time information as a result of the determination of the use time determination unit, whether or not a traffic volume generated with respect to the use time exceeds a preset threshold ratio; and a normal connection state determination unit for determining, if it is determined that the traffic volume exceeds the preset threshold ratio as a result of the determination of the traffic use time determination unit, connection of the terminal device currently connected and generating the second device profile information as an abnormal connection.

In addition, the abnormal behavior detection system according to one aspect of the present invention may further include a traffic tolerance determination unit for determining, if it is determined that the use time per connection does not exceed the average use time information as a result of the determination of the use time determination unit, whether or not the traffic volume tolerable with respect to the average traffic volume information per connection exceeds a threshold ratio.

In this case, the traffic allowance value determination unit according to one aspect of the present invention may determine connection of the terminal device currently connected and generating the second device profile information as a normal connection if the traffic volume tolerable with respect to the average traffic volume information per connection does not exceed the threshold ratio as a result of the determination of the traffic tolerance determination unit and as an abnormal connection if the traffic volume tolerable with respect to the average traffic volume information per connection exceeds the threshold ratio.

In this case, the first traffic volume determination unit according to one aspect of the present invention may determine connection of the terminal device currently connected and generating the second device profile information as a normal connection if the traffic volume per connection does not exceed the average traffic volume information as a result of the determination.

In this case, the traffic use time determination unit according to one aspect of the present invention may determine connection of the terminal device currently connected and generating the second device profile information as a normal connection if the traffic volume generated with respect to the use time does not exceed a preset threshold ratio.

### BRIEF DESCRIPTION OF THE DRAWINGS

FIG. 1 is a view exemplarily showing a behavior detection system 1000 according to an embodiment of the present invention.

FIG. 2 is a view exemplarily showing the configuration of an abnormal behavior detection system 300 for detecting an abnormal connection behavior according to a first embodiment of the present invention.

FIGS. 3 to 7 are views showing states of data obtained from each configuration of the abnormal behavior detection system 300 according to a first embodiment of the present invention.

FIG. 8 is a view exemplarily showing the configuration of an abnormal behavior detection system 300 for detecting an abnormal use behavior based on a profile according to a second embodiment of the present invention.

FIG. 9 is a view showing a graph of traffic volume accumulated with respect to use time according to a second embodiment of the present invention.

### DETAILED DESCRIPTION OF THE PREFERRED EMBODIMENT

The preferred embodiments of the invention will be hereafter described in detail with reference to the accompanying drawings so that those skilled in the art may easily embody the present invention. Furthermore, in the drawings illustrating the embodiments of the present invention, elements having like functions will be denoted by like reference numerals and details thereon will not be repeated.

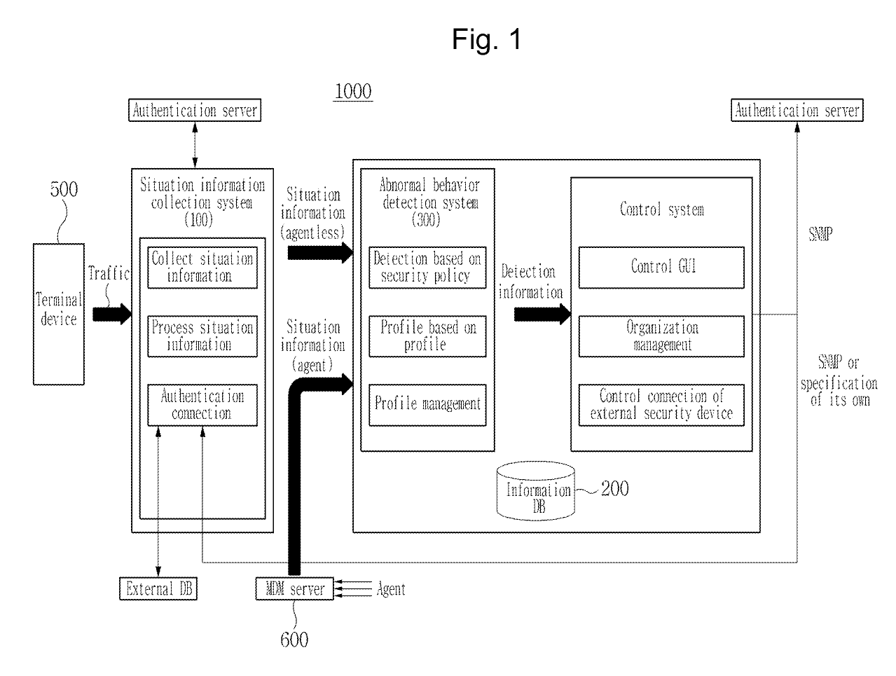

FIG. 1 is a view exemplarily showing a behavior detection system 1000 according to an embodiment of the present invention.

As shown in FIG. 1, the behavior detection system 1000 according to an embodiment of the present invention is configured to include a situation information collection system 100, an information database 200, an abnormal behavior detection system 300, a control system 400, a terminal device 500, and an MDM server 600 in order to detect abnormal behaviors in a BOYD and smart work environment.

First, the situation information collection system 100 according to the present invention collects situation information related to a time point of authentication, connection or disconnection from the terminal device and an MDM agent device.

At this point, the collected situation information includes a connection address (an ID, a company, authority, a current state and the like), a connection pattern (an authentication result, the number of authentication failures and the like), network behavior information (a connection time, a location and the like) and disconnection time information. Although the situation information is divided into a periodic transmission data and a non-periodic (real-time) transmission data, all situation information is considered as non-periodic transmission data and collected by the situation information collection system 100.

Next, the information database 200 according to the present invention processes the situation information collected by the situation information collection system 100 into connection, use and agent situation information and, at the same time, performs profiling on the situation information at the time of disconnection to process and store the situation information as profile information.

At this point, the stored profile information includes a user profile, a terminal device profile and a connection behavior profile. At this point, the user profile includes user authority information, a total number of authentication failures, a recent connection date and time, an initial connection date and time, a total use time and a total number of connections, and the terminal device profile includes a device ID, a device type, an operating system (OS), a browser, a device name, a MAC address, an installation state of an agent, a locking state of a screen, information on installed programs, a setting of automatic log-in and a recent connection date and time. In addition, the connection behavior profile includes connection behavior pattern information.

Next, the abnormal behavior detection system 300 according to the present invention detects abnormal behaviors related to connection behaviors, use behaviors, authentication behaviors and the like of the terminal device 500 and/or the MDM server 600 using the profile information and the connection, use and agent situation information stored in the information database 200. For example, the abnormal behavior detection system 300 detects abnormal behaviors related to connection and use of the terminal device of a user using normal profile information included in the profile information.

Next, the control system 400 according to the present invention receives information on the abnormal behaviors detected by the abnormal behavior detection system 300 and controls the information through a control GUI, sets and manages a security policy, and controls connection to an external security device. One end of such a control system 400 is connected to the information database 200 and/or the abnormal behavior detection system 300, and the other end thereof is connected to the external security device (e.g., Genian, Wapples or the like).

Next, the terminal device 500 according to the present invention is a mobile device owned by an individual, such as a smart phone, a laptop computer, a tablet computer or the like, which is a terminal for assessing IT resources internal to a company, such as a database, an application, or the like, and processing a work.

In other words, the terminal device 500 generates situation information related to a time point of authentication, connection or disconnection in a BYOD and smart work environment. Since the situation information is described above, additional description thereof is omitted.

Finally, the MDM server 600 according to the present invention is located in a DMZ or a screened subnet and functions as a gateway for communications such as authentication connection between an intra network of a company and a mobile device, Direct Push Update and the like. A plurality of agents is connected to the MDM server 600 and generates the situation information described above.

Hereinafter, the abnormal behavior detection system 300 described above will be described in further detail.

### First Embodiment

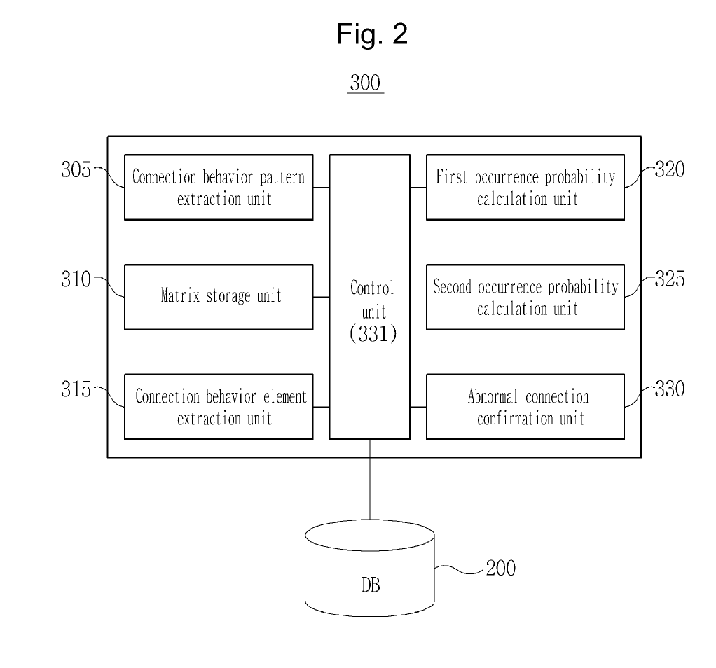

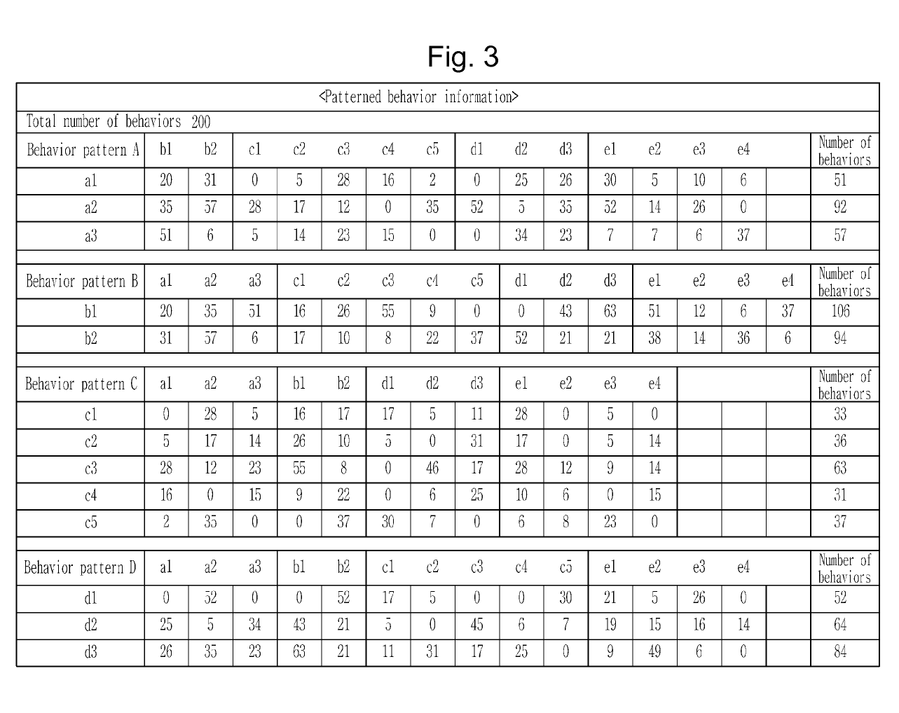

FIG. 2 is a view exemplarily showing the configuration of an abnormal behavior detection system 300 for detecting an abnormal connection behavior according to a first embodiment of the present invention, and FIGS. 3 to 7 are views showing states of data obtained from each configuration of the abnormal behavior detection system 300 according to a first embodiment of the present invention. FIGS. 3 to 7 will be subsidiarily described while describing FIG. 2.

As shown in FIG. 2, the abnormal behavior detection system 300 according to a first embodiment of the present invention is configured to include a connection behavior pattern extraction unit 305, a matrix storage unit 310, a connection behavior element extraction unit 315, a first occurrence probability calculation unit 320, a second occurrence probability calculation unit 325, an abnormal connection confirmation unit 330 and a control unit 331 in order to detect an abnormal connection behavior using a normal profile among profile information extracted in a BYOD and/or smart work environment.

First, the connection behavior pattern extraction unit 305 according to the present invention extracts normal profile information among the profile information stored in the information database 200 described above in FIG. 1 and extracts a plurality of pieces of connection behavior pattern information having connection behavior elements of a same series from the normal profile information.

For example, the connection behavior pattern extraction unit 305 extracts a plurality of pieces of connection behavior pattern information (A and B) having connection behavior elements such as a1, a2 and a3 and connection behavior elements such as b1, b2 and b3, which form a same series.

In other words, connection behavior pattern information A has connection behavior elements such as a1, a2 and a3 forming a similar connection behavior, and connection behavior pattern information B has connection behavior elements such as b1, b2 and b3 forming a similar connection behavior. This example may be summarized as shown in (Table 1).

TABLE 1

| Connection behavior information | A | B | C |
|---|---|---|---|
| Connection behavior elements | a1, a2, | b1, b2, | c1, c2, |
| | a3 . . . | b3 . . . | c3 . . . |

Next, the matrix storage unit 310 according to the present invention creates a matrix of connection behavior pattern information by matching the plurality of pieces of connection behavior pattern information other than certain connection behavior pattern information among the plurality of pieces of connection behavior pattern information of, for example, A, B and C, extracted by the connection behavior pattern extraction unit 305 to the certain connection behavior pattern information for each piece of the connection behavior pattern information.

For example, connection behavior pattern information B and C correspond to the other plurality of pieces of connection behavior pattern information when the certain connection behavior pattern information is A, and connection behavior pattern information A and C correspond to the other plurality of pieces of connection behavior pattern information when the certain connection behavior pattern information is B.

The matrix information (patterned behavior information) created as a matrix in this manner may be summarized as shown in FIG. 3.

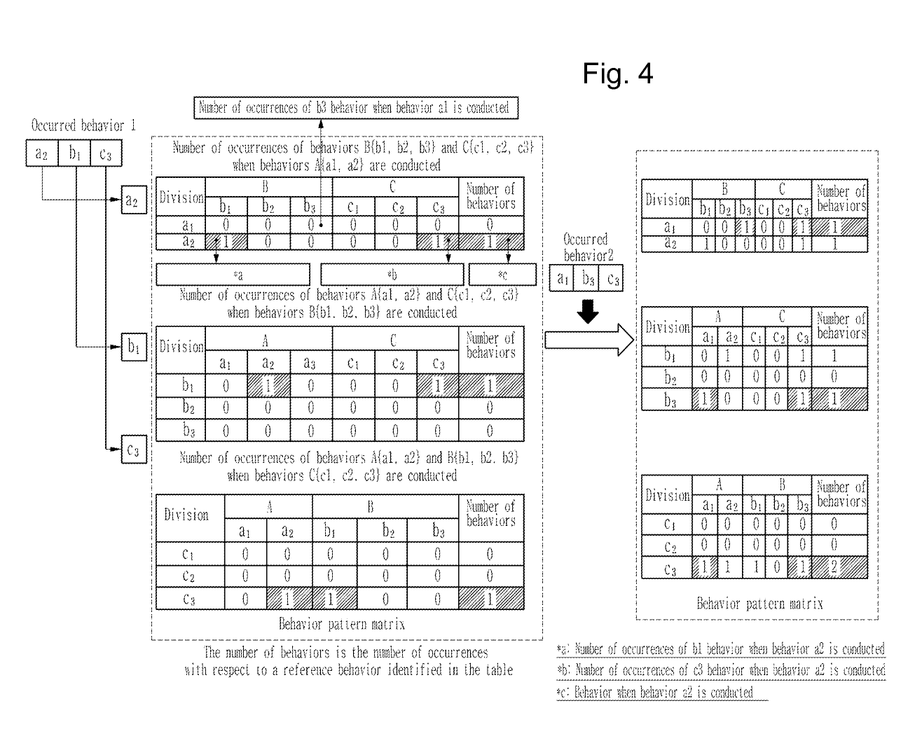

Next, the connection behavior element extraction unit 315 according to the present invention extracts a first connection behavior element of the first current behavior included in the certain connection behavior pattern information. For example, if current behaviors are occurred in order of a2, b1 and c3, first connection behavior elements such as a2, b1 and c3 may be respectively extracted as current behavior elements. An example of the extracted first connection behavior elements a2, b1 and c3 is shown in FIG. 4.

Next, the first occurrence probability calculation unit 320 according to the present invention matches the first connection behavior elements extracted by the connection behavior element extraction unit 315 under the behaviors of the other connection behavior pattern elements as shown in FIG. 4. For example, the first connection behavior elements such as A{a1, a2 } are matched under the behaviors of the respective connection behavior pattern elements such as B{b1, b2, b3} and C{c1, c2, c3} as shown in FIG. 4.

Then, the first occurrence probability calculation unit 320 according to the present invention calculates current behavior occurrence probabilities of the first connection behavior elements such as a1 and a2 under the behaviors of the other connection behavior pattern elements such as B{b1, b2, b3} and C{c1, c2, c3} or calculates current behavior occurrence probabilities of the first connection behavior elements such as b1, b2 and b3 under the behaviors of the other connection behavior pattern elements such as A{a1, a2, a3} and C{c1, c2, c3}.

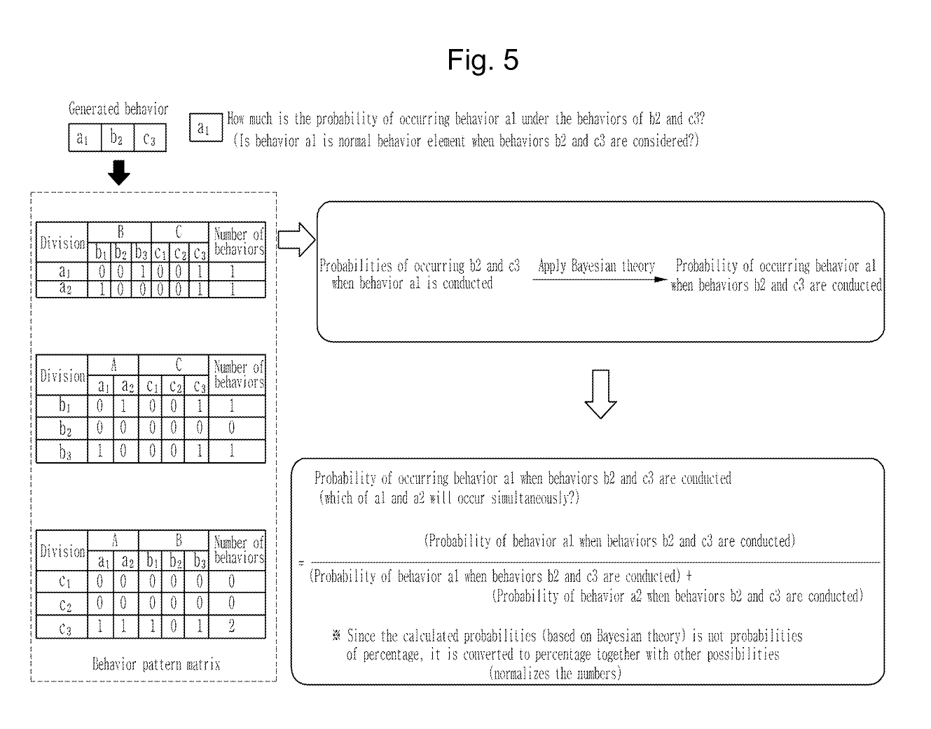

At this point, an example of the calculated behavior occurrence probabilities of the first connection behavior elements is as shown in FIG. 5. That is, FIG. 5 shows only a probability of current occurrence of behavior a1 (a1 is a behavior of the first connection behavior element) when behaviors b2 and b3 are conducted, by applying the Bayesian theory. Current occurrence probabilities of the other current behaviors may be calculated in the same manner as calculating the probability of a1.

Next, the second occurrence probability calculation unit 325 according to the present invention determines whether or not other second connection behavior elements for calculating the current behavior occurrence probability exist among the certain connection behavior pattern information.

For example, as described above for the connection behavior element extraction unit 315, when the first connection behavior element selected in the first place is a2, b1 selected in the second place corresponds to the second connection behavior element, and, subsequently, when the first connection behavior element is b1, c3 coming in next turn will correspond to the second connection behavior element. Accordingly, the second occurrence probability calculation unit 325 according to the present invention determines whether or not the second connection behavior elements such as b1 and c3 exist.

Subsequently, if it is determined that the second connection behavior elements such as b1 and c3 still exist as a result of the determination, the second occurrence probability calculation unit 325 according to the present invention extracts the second connection behavior elements such as b1 and c3 and further calculates current behavior occurrence probabilities for the second connection behavior elements b1 and c3 in the same manner as the calculation of the first occurrence probability calculation unit 320 described above.

Like this, the second connection behavior elements mean a plurality of currently occurring behaviors unlike the first connection behavior elements indicating only any one of connection behavior elements. Accordingly, it is possible to determine whether or not all subsequent connection behavior elements exist and further calculate respective current behavior occurrence probabilities like calculating the current behavior occurrence probability of the first connection behavior element.

Next, if it is determined that the second connection behavior elements do not exist any more as a result of the determination of the second occurrence probability calculation unit 325, the abnormal connection confirmation unit 330 according to the present invention calculates a weighted average of the behavior occurrence probabilities for each of the first connection behavior element and the second connection behavior element.

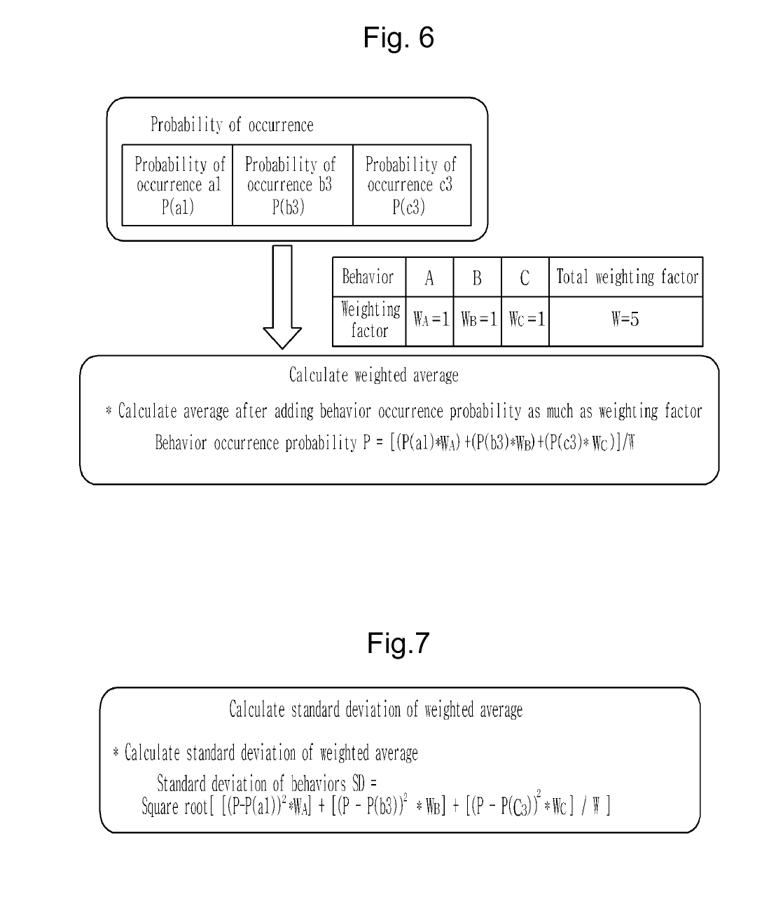

For example, as shown in FIG. 6, if the probability of occurrence of a1 is defined as P(a1), the probability of occurrence of b3 is defined as P(b3), the probability of occurrence of c3 is defined as P(c3), the weighting factor of behavior A is defined as W_{A}=1, the weighting factor of behavior B is defined as W_{B}=3, and the weighting factor of behavior C is defined as W_{C}=5, the behavior occurrence probability based on the weighted average may be calculated as (P)=[(P(a1)*W_{A})+(P(b3)*W_{B})+(P(c3)*W_{C})]/W.

Subsequently, the abnormal connection confirmation unit 330 according to the present invention calculates the weighted average of the behavior occurrence probability for each of the confirmed first and second connection behavior elements and then calculates a standard deviation using a formula of a standard deviation SD (a behavior standard deviation) as shown in FIG. 7 based on a result of calculating the weighted average.

Then, the abnormal connection confirmation unit 330 according to the present invention confirms existence of an abnormal connection behavior in a BYOD and smart work environment by determining whether or not a connection behavior is within the range of a normal behavior occurrence probability and a normal standard deviation using the weighted average and the standard deviation for the behavior occurrence probabilities calculated as described above.

For example, if a normal behavior probability P and a normal standard deviation SD are confirmed according to a standard of normal as shown in tables 2 and 3, whether the behavior occurrence probability and the standard deviation are normal or abnormal may be known, and thus existence of an abnormal connection behavior such as a suspected behavior, a warned behavior or an abnormal behavior may be known.

TABLE 2

| Division | Standard of normal |
|---|---|
| Probability of normal behavior (P) | 60 < P |
| Normal standard deviation (SD) | SD > 20 |

TABLE 3

Division

| Probability of | | |
|---|---|---|
| occurrence of | Standard | |
| behavior | deviation | Final decision |
| Normal | Abnormal | Suspected behavior |
| Abnormal | Normal | Warned behavior |
| Normal | Abnormal | Abnormal behavior |

Here, if the behavior probability is normal and the standard deviation is abnormal, it means that some of behavior elements are less probable to occur although a connection behavior is probable to occur, and if the behavior probability is abnormal and the standard deviation is normal, it means that the overall probability of occurring a connection behavior is low (the standard deviation is meaningless since the probability of occurrence of each of behavior elements is low).

Contrarily, a case in which both the behavior probability and the standard deviation are abnormal is generally difficult to occur, and it means that possibility of occurring such a situation is extremely low even for some behavior elements.

Finally, the control unit 331 according to the present invention controls flow of data among the connection behavior pattern extraction unit 305, the matrix storage unit 310, the connection behavior element extraction unit 315, the first occurrence probability calculation unit 320, the second occurrence probability calculation unit 325 and the abnormal connection confirmation unit 330. Accordingly, a corresponding unique function is performed in each configuration.

As described above, in this embodiment, since existence of an abnormal connection behavior may be known using the finally calculated behavior occurrence probability and behavior standard deviation, further excellent security compared with that of the existing NAC and MDM techniques may be maintained in a BYOD and smart work environment.

### Second Embodiment

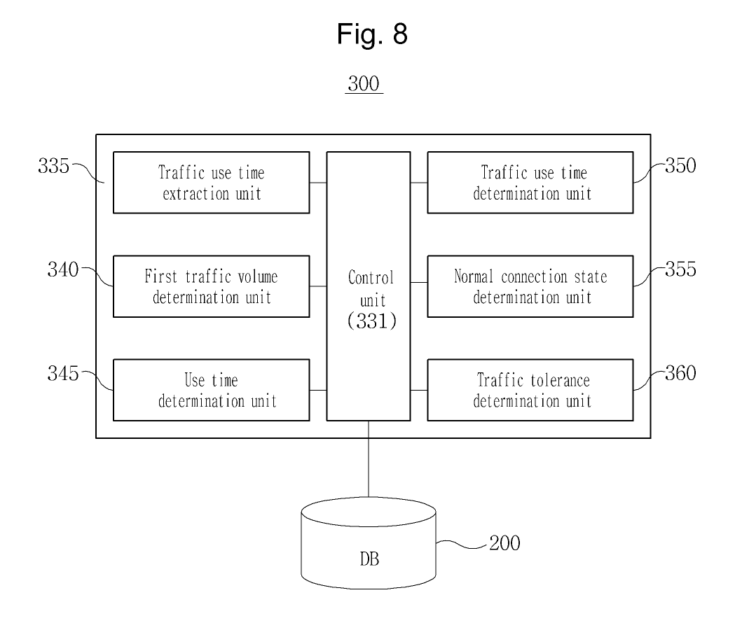

FIG. 8 is a view exemplarily showing the configuration of an abnormal behavior detection system 300 for detecting an abnormal use behavior based on a profile according to a second embodiment of the present invention.

As shown in FIG. 8, the abnormal behavior detection system 300 according to a second embodiment of the present invention is configured to include a traffic use time extraction unit 335, a first traffic volume determination unit 340, a use time determination unit 345, a traffic use time determination unit 350, a normal connection state determination unit 355 and a traffic tolerance determination unit 360 in order to detect an abnormal use behavior using profile information extracted in a BYOD and/or smart work environment.

First, the traffic use time extraction unit 335 according to the present invention inquires first device profile information (which means device profile information of a plurality of users) among the profile information stored in the information database 200 described above in FIG. 1 and extracts average traffic volume information and average use time information per connection.

Here, the profile information includes a user profile configured of user authority information, a total number of authentication failures, a recent connection date and time, an initial connection date and time, a total use time and a total number of connections, a first device profile configured of a device ID, a device type, an OS, a browser, a device name, a MAC address, an installation state of an agent, a locking state of a screen, information on installed programs, a setting of automatic log-in, and a recent connection date and time, and a connection behavior profile configured of connection behavior pattern information.

In this case, the traffic use time extraction unit 335 according to the present invention extracts average traffic volume information and average use time information generated per connection from the first device profile among the profile information described above. At this point, an average traffic volume of the average traffic volume information may be calculated by a formula of ‘number of transmitted and received packets (targeting a destination)/total number of connections of device’, and an average use time of the average use time information may be calculated by a formula of ‘total use time of device/total number of connections of device’.

Next, the first traffic volume determination unit 340 according to the present invention determines whether or not a traffic volume per connection acquired from second device profile information generated while being connected exceeds the average traffic volume information extracted by the traffic use time extraction unit 335.

The average traffic volume information applied as the standard of determination means an average amount of data generated per connection by the user through a currently used device. Meanwhile, the second device profile information means device profile information acquired from the currently used device.

If the traffic volume per connection does not exceed the average traffic volume information, the first traffic volume determination unit 340 determines connection of the terminal device currently connected and generating the second device profile information as a normal connection.

Next, if it is determined that the traffic volume per connection exceeds the average traffic volume information as a result of the determination of the first traffic volume determination unit 340, the use time determination unit 345 according to the present invention assumes the connection of the currently connected terminal device as an abnormal connection and determines whether or not a use time per connection acquired from the second device profile information exceeds the average use time information.

The average use time information applied as the standard of determination means an average use time when the user connects through a currently used device (a terminal device), and the use time means a final communication time, i.e., a connection time.

Next, if it is determined that the use time per connection exceeds the average use time information as a result of the determination of the use time determination unit 345, the traffic use time determination unit 350 according to the present invention determines whether or not a traffic volume generated with respect to the use time exceeds a preset threshold ratio.

At this point, the threshold ratio means a range of an allowed traffic volume larger than the average traffic volume within the average use time. Contrarily, a traffic volume with respect to the use time means an average amount of data used by the user through the currently used device at a specific use time (targeting a destination), which can be calculated by a formula of ‘number of transmitted and received packets (targeting a destination)/total use time of device×time of using measurement target’.

Next, if it is determined that the traffic volume does not exceed the preset threshold ratio as a result of the determination of the traffic use time determination unit 350, the normal connection state determination unit 355 according to the present invention determines whether or not a traffic volume tolerable with respect to the average traffic volume information per connection exceeds a threshold ratio.

At this point, if it is determined that the traffic volume tolerable with respect to the average traffic volume information per connection exceeds the threshold ratio as a result of the determination of the normal connection state determination unit 355, connection of the terminal device currently connected and generating the second device profile information is determined as an abnormal connection.

Next, if it is determined that the use time per connection does not exceed the average use time information as a result of the determination of the use time determination unit 345, the traffic tolerance determination unit 360 according to the present invention determines whether or not the traffic volume tolerable with respect to the average traffic volume information per connection exceeds the threshold ratio.

If it is determined that the traffic volume tolerable with respect to the average traffic volume information per connection does not exceed the threshold ratio as a result of the determination of the traffic tolerance determination unit 360, connection of the terminal device currently connected and generating the second device profile information is determined as a normal connection, and if it is determined that the traffic volume tolerable with respect to the average traffic volume information per connection exceeds the threshold ratio, connection of the terminal device currently connected and generating the second device profile information is determined as an abnormal connection.

As described above, in the embodiment, since it may be determined whether or not a currently connected terminal device is abnormal through the determination steps described above, security in a BOYD and smart work environment may be enhanced.

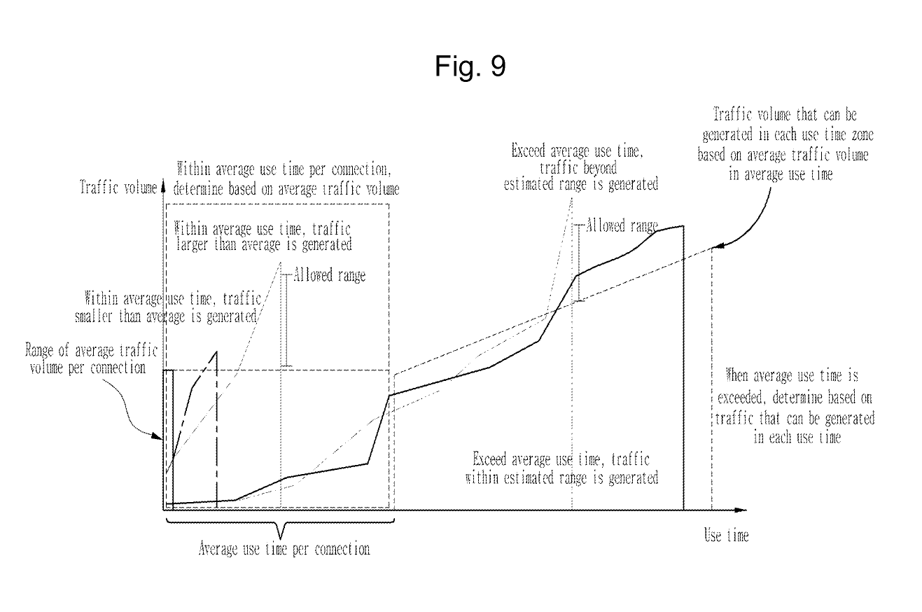

FIG. 9 is a view showing a graph of traffic volume accumulated with respect to use time according to a second embodiment of the present invention.

As shown in FIG. 9, in the graph of traffic volume accumulated with respect to use time according to a second embodiment of the present invention, it may be possible to confirm various graph states for detecting abnormal use, including a graph of an average use time per connection and a range of traffic volume which may be generated in each use time zone based on an average traffic volume in an average use time.

Meanwhile, although the abnormal behavior detection system 300 described above detects an abnormal behavior based on past behavior information as described with reference to FIGS. 2 to 8, it may further detect an abnormal behavior based on real-time behavior information.

That is, the abnormal behavior detection system 300 according to the present invention may further detect connection, use and abnormal behavior of a connected terminal device of a user conducted on an agent, based on real-time behavior information stored in the information database 200, such as the connection, use and agent situation information, and may further detect an abnormal behavior related to the connection and use of the terminal device of the user based on the profile information according to a security policy.

As described above, according to the present invention, since situation information is processed as connection, use and agent situation information and profile information and an abnormal behavior such as connection, use and the like of a terminal device is detected using the information, it is effective in that security in the BYOD and smart work environment may be improved.

In addition, according to the present invention, since an abnormal connection behavior and a malicious behavior may be easily determined by calculating a current behavior occurrence probability for a corresponding connection behavior element under the behaviors of the other connection behavior pattern elements after extracting a plurality of connection behavior elements, it is effective in that security in the BYOD and smart work environment may be improved.

In addition, according to the present invention, since an abnormal use behavior may be easily determined by determining whether or not an average traffic volume and an average use time per connection are exceeded, it is effective in that security in the BYOD and smart work environment may be improved.

Particularly, as described above, if an abnormal connection behavior is detected, it is effective in that the existing NAC and MDM techniques which are limited in protecting internal resources in a BYOD and smart work environment may be replaced.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A behavior detection system for detecting an abnormal behavior of a user in a Bring Your Own Device (BYOD) and smart work environment, the system comprising:
a situation information collection system for collecting situation information from a terminal device and an MDM agent device;
an information database for processing and storing the collected situation information as connection, use and agent situation information and profiling the situation information at a time of disconnection to process and store the situation information as profile information; and
an abnormal behavior detection system for detecting an abnormal behavior related to connection and use of the terminal device of the user using normal profile information included in the profile information.

2. The system according to claim 1, wherein the abnormal behavior detection system detects whether or not the user violates a policy according to a set security policy based on a profile element such as a connection location and a type of used device, processed information and a specific reference value and further detects an abnormal behavior related to the connection and use of the terminal device of the user based on the normal profile information.

3. The system according to claim 1, wherein the abnormal behavior detection system includes:
a connection behavior pattern extraction unit for extracting a plurality of pieces of connection behavior pattern information having connection behavior elements of a same series from the normal profile information among the profile information;
a matrix storage unit for creating a matrix of connection behavior pattern information by matching the plurality of pieces of connection behavior pattern information other than certain connection behavior pattern information among the plurality of pieces of connection behavior pattern information to the certain connection behavior pattern information for each piece of the connection behavior pattern information;
a connection behavior element extraction unit for extracting a first connection behavior element of the first current behavior included in the certain connection behavior pattern information; and
a first occurrence probability calculation unit for calculating a current behavior occurrence probability of the first connection behavior element under behaviors of the other connection behavior pattern elements.

4. The system according to claim 3, wherein the abnormal behavior detection system further includes a second occurrence probability calculation unit for determining whether or not other second connection behavior elements for calculating the current behavior occurrence probability exist among the certain connection behavior pattern information and, if other second connection behavior elements for calculating the current behavior occurrence probability exist as a result of the determination, extracting the second connection behavior elements of a next current behavior included in the certain connection behavior pattern information and further calculating a current behavior occurrence probability for each of the second connection behavior elements.

5. The system according to claim 4, wherein the abnormal behavior detection system further includes an abnormal connection confirmation unit for confirming, if it is determined that the other second connection behavior elements do not exist any more as a result of the determination, whether or not there is an abnormal connection behavior by calculating a weighted average and a standard deviation of the behavior occurrence probabilities for each of the first connection behavior element and the second connection behavior element and determining whether or not a connection behavior is within a range of a normal behavior occurrence probability and a normal standard deviation.

6. The system according to claim 1, wherein the abnormal behavior detection system includes:
a traffic use time extraction unit for inquiring first device profile information among the profile information and extracting average traffic volume information and average use time information per connection;
a first traffic volume determination unit for determining whether or not a traffic volume per connection acquired from second device profile information generated while being connected exceeds the average traffic volume information;
a use time determination unit for determining, if it is determined that the traffic volume per connection exceeds the average traffic volume information as a result of the determination of the first traffic volume determination unit, whether or not a use time per connection acquired from the second device profile information exceeds the average use time information;
a traffic use time determination unit for determining, if it is determined that the use time per connection exceeds the average use time information as a result of the determination of the use time determination unit, whether or not a traffic volume generated with respect to the use time exceeds a preset threshold ratio; and
a normal connection state determination unit for determining, if it is determined that the traffic volume exceeds the preset threshold ratio as a result of the determination of the traffic use time determination unit, connection of the terminal device currently connected and generating the second device profile information as an abnormal connection.

7. The system according to claim 6, wherein the abnormal behavior detection system further includes a traffic tolerance determination unit for determining, if it is determined that the use time per connection does not exceed the average use time information as a result of the determination of the use time determination unit, whether or not the traffic volume tolerable with respect to the average traffic volume information per connection exceeds a threshold ratio.

8. The system according to claim 7, wherein the traffic tolerance determination unit determines connection of the terminal device currently connected and generating the second device profile information as an abnormal connection if the traffic volume tolerable with respect to the average traffic volume information per connection does not exceed the threshold ratio as a result of the determination of the traffic tolerance determination unit and as a normal connection if the traffic volume tolerable with respect to the average traffic volume information per connection exceeds the threshold ratio.

9. The system according to claim 6, wherein if the traffic volume per connection does not exceed the average traffic volume information as a result of the determination, the first traffic volume determination unit determines connection of the terminal device currently connected and generating the second device profile information as a normal connection.

10. The system according to claim 6, wherein if the traffic volume generated with respect to the use time does not exceed a preset threshold ratio, the traffic use time determination unit determines connection of the terminal device currently connected and generating the second device profile information as a normal connection.
